(19) United States
(12) Patent Application Publication
(10) Pub. No.: US 2006/0283719 A1
(43) Pub. Date: Dec. 21, 2006

(54) Artist's palette

(76) Inventor: Parnaos Surabischwili, Media, PA (US)

Correspondence Address: Robert G. Rosenthal, Suite 200, 5856 Faringdon Place, Raleigh, NC, 27609, US

(21) Appl. No.: 11/409,394

(22) Filed: Apr. 21, 2006

Related U.S. Application Data
(60) Provisional application No. 60/682,535, filed on May 20, 2005.

(51) Int. Cl. B44D 3/04; B65D 71/00; B44D 3/00

(52) U.S. Cl. 206/1.7; 206/1.8; 206/575

(57) ABSTRACT

The invention comprises an artist's palette in the form of a panel having a shape adapted to overlie at least a portion of the arm of the artist and having a notch positioned in the panel along one edge thereof. The notch has dimensions sufficient to receive the arm of the artist and includes a curved jaw member for closing the open dimension of the notch and further wherein the jaw member is moveable between a first open position wherein the arm of the artist may be inserted within the notch and a second substantially closed position wherein the palette is supported by the arm of the artist. The palette may be inverted so that it may be employed by both left and right handed persons.

### PRIORITY CLAIM

This patent application claims priority from U.S. Provisional Patent Application Ser. No. 60/682,535 filed May 20, 2005.

### BACKGROUND OF THE INVENTION

This invention relates generally to the field of artist's palettes and more particularly to an ergonomic artist's palette that permits use of the hand of the palette supporting arm.

### BACKGROUND OF THE INVENTION

Artist's palettes are well known and have been in use for hundreds of years. A palette of this type commonly comprises a rigid panel, e.g., of wood, metal, plywood or plastic material and the like, having dimensions appropriate for support by the artist's hand, and is shaped so that it may be easily held by the artist. Typically, a palette includes a thumb hole near one end of the panel which aids in holding the palette. Palettes may be of a wide variety of sizes and shapes, and some special forms of palettes may include additional structures such pans, trays or other vessels for holding coloring materials and various liquids used in art work. Generally, all palettes require a thumb hole or equivalent configuration arranged so that the artist may grasp and hold the palette with one hand while working with the other hand.

Exemplary of the artist's palette is U.S. Pat. No. 2,271,294 to E. Ford for an artist's palette which discloses a flat body portion formed of wood or other suitable material that is substantially rectangular in shape. One of the short edges is provided with a cut-away portion or recess and spaced inwardly from the recess and within a hand's reach thereof is a thumb opening. Along one of the long edges of the body is formed a recess. The wall of this recess at the end thereof closest to the thumb opening is provided with a shoulder or nose portion.

In use, the palette is positioned on the arm with the thumb through the opening and the fingers around and gripping the wall of the recess. The forearm is positioned in the recess so that the nose portion interlocks therewith. When in this position, the palette is in proper balance on the arm and is prevented from slipping off by the nose, but the hand of the supporting arm is required to support the palette.

U.S. Pat. No. 2,656,633 to Bergen discloses a rigid panel, in one of the well known palette shapes, such as an oval, having a thumb hole arrangement which includes an annulus or like structure more or less annularly arranged, of a suitably flexible or resilient material (such as rubber, foam rubber or equivalents) that acts to pad the thumb and operates to reduce fatigue and alleviate discomfort, bu which again occupies the palette holding hand.

U.S. Pat. No. 2,878,590 to Dodge discloses a multifunction artist's palette that comprises a circular base the underside of which mounts a strap into which the artist's hand is placed to support the apparatus. Further, the top surface mounts a number of clips which are adapted to hold tubes of paint and a color chart to facilitate color mixing.

An object of the present invention is to provide an artist's palette that overcomes the drawbacks and deficiencies of the prior art.

Another object of the present invention is to provide an artist's palette that is easy to use.

A further object of the present invention is to provide an artist's palette that is inexpensive to produce.

A still further object of the present invention is to provide an artist's palette that will remain stable on the artist's arm while permitting independent use of the hand of the supporting arm.

Yet another object of the present invention is to provide an artist's palette that may be used for an extended time while minimizing fatigue.

### SUMMARY OF THE INVENTION

The benefits and advantages of the present invention are achieved in an artist's palette comprising a panel having a shape adapted to overlie at least a portion of the arm of the artist and having a notch positioned in the panel along one edge thereof. The notch has dimensions sufficient to receive the arm of the artist and includes a curved jaw member for closing the open dimension of the notch means and further wherein the jaw member is moveable between a first open position wherein the arm of the artist may be inserted within the notch and a second substantially closed position wherein the palette is supported by the arm of the artist.

### BRIEF DESCRIPTION OF THE DRAWINGS

Some of the features and advantages of the invention having been briefly stated, others will appear from the detailed description which follows, when take in connection with the accompanying drawings, in which—

FIG. 1 is a perspective view of the artist's palette according to the present invention illustrating the palette positioned on the arm of an artist.

FIG. 2 is a plan view of the artist's palette according to the present invention illustrating the jaw member in both the open and closed positions.

FIG. 3 is a bottom view o the artist's palette according to the present invention illustrating the jaw member in the closed position.

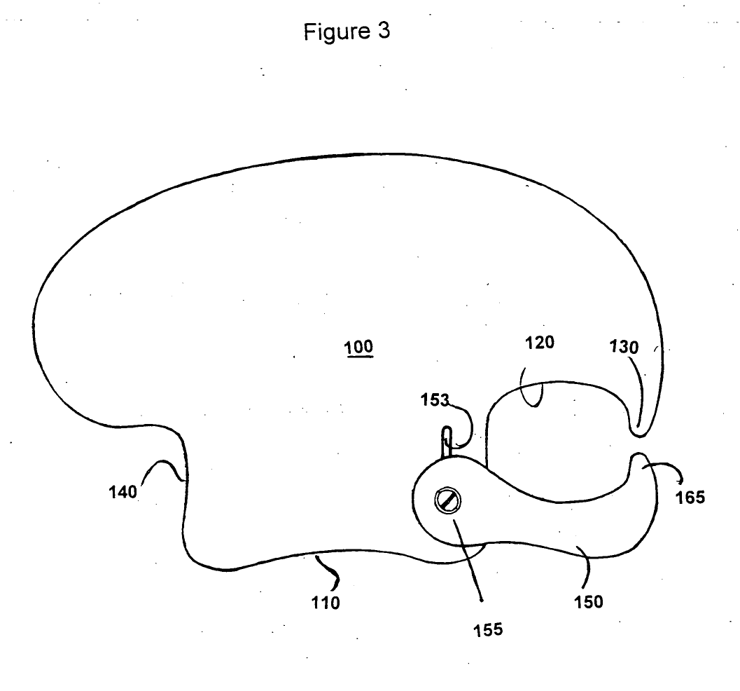

### DETAILED DESCRIPTION OF THE PREFERRED EMBODIMENT

While the present invention will be described more fully hereinafter with reference to the accompanying drawings, in which a particular embodiment is shown, it is to be understood at the outset that persons skilled in the art may modify the invention herein described while still achieving the favorable results of this invention, Accordingly, the description which follows is to be understood as a broad teaching disclosure directed to persons of skill in the appropriate arts and not as limiting upon the present invention.

Referring now to the drawings, the artist's palette generally indicated at 100 is there illustrated. The palette 100 is usually made of a rigid lightweight material so as not to fatigue the artist's arm. The most commonly used material is a thin plywood with the edges smoothed by sanding. Other types of rigid materials that may be employed include plastics, solid wood, thin sheet metal (aluminum) and other equivalent lightweight and rigid materials. More sophisticated palettes may include indentations or trays for holding various art materials such as watercolors, openings for holding paintbrushes when not in use, etc. In accordance with the present invention, the palette 100 may be regarded as substantially oval in shape. One half of the oval maintains the natural curvature and the other half is shaped to facilitate use as explained herein below. The upper surface of the palette is used by the artist as they see fit to hold the required art materials which may include paints, watercolors, clay, solvents, other paint chemicals such as drying agents, paintbrushes and the like.

The lower half of the palette 100 includes a slight concave curvature 110 in the central portion thereof which when held against the ventral or stomach of the artist and generally follows the anatomical lines of the torso. A curved notch means or notch 120 is located on one side of the palette 100 and includes a hooked nose portion 130 and on the opposite side of the lower section is a curved indented section 140.

A means for closing the open dimension of the notch comprises a jaw member or jaw 150 that is moveable between a first open position and a second substantially closed position. The jaw 150 is pivotally connected to the palette 100 proximate the notch 120. As shown in the figures, a slot 153 is provided in the palette 100 and the jaw 150 is connected to the palette with an appropriate connector such as a screw 155 and wing nut 160 which are slidably inserted in the slot 153 at one end. The opposite end of jaw 150 defines a second nose portion 165. Other acceptable connectors may be selected from the group consisting of nut and bolt, nail, rivet, pop-rivet, screw, peg, grommet and hook and loop fastener as may be appropriate in view of the particular palette material employed. Further, in the event that the palette 100 is molded, the jaw 150 may be attached with a snap fit connector, will known to those skilled in the art. The slot 153 serves to make the palette 100 more adjustably comfortable for arms of varying size.

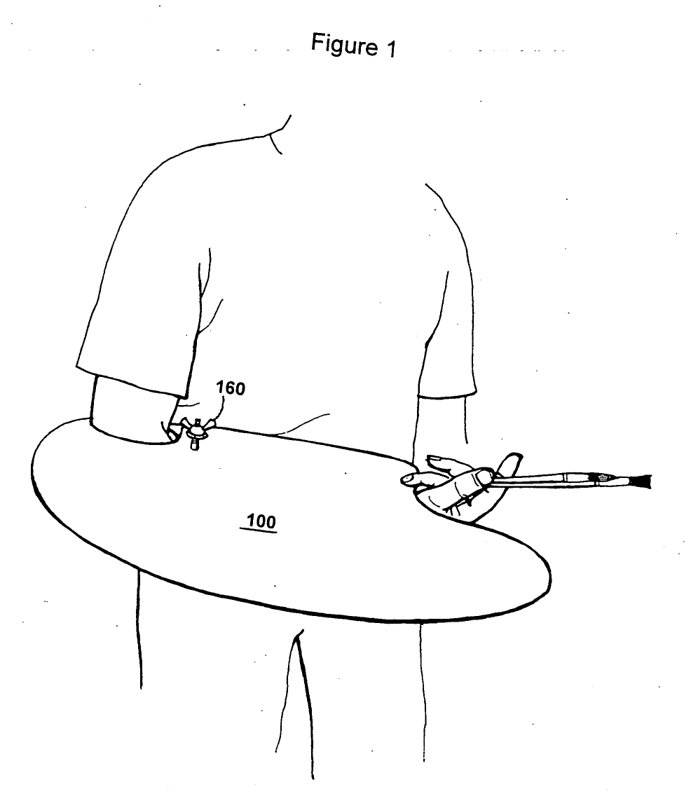

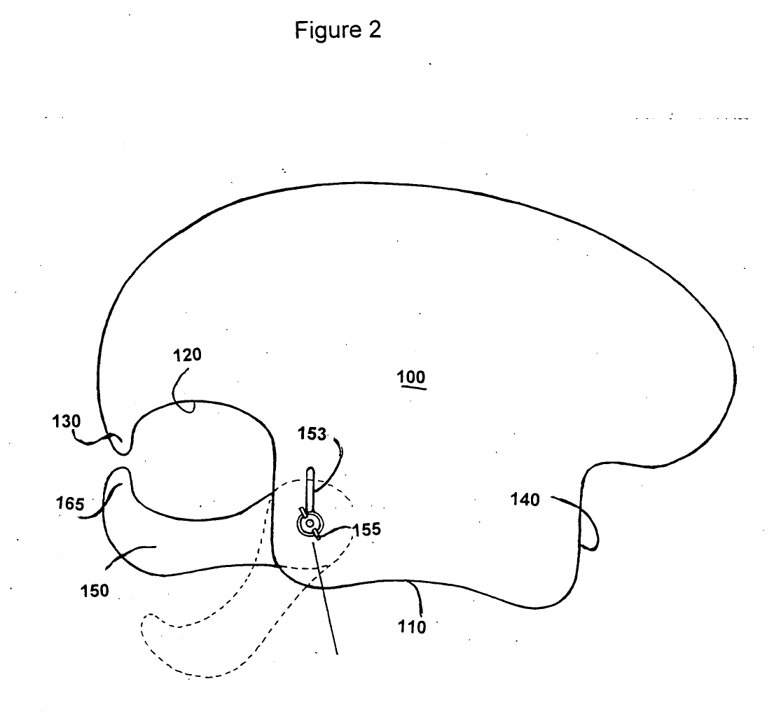

In use, the wing nut 160 is loosened such that the jaw 165 moves freely to the open position as best illustrated by the dotted lines in FIG. 2. The notch 120 is placed against the upper arm of the artist as shown in FIG. 1 and the jaw 150 is closed such that the respective nose portions 130 and 165 are substantially facing one another and the open dimension is substantially spanned. Further, the jaw 150 is moved within slot 153 so as to be comfortably snug against the artist's arm. The wing nut is then tightened such that the jaw 10 does not easily move. It will be noted that the distance from the notch 120 to indented section 140 is approximately the length of the artist's forearm. The present invention enables the palette to adequately supported from below by the forearm without the need for a thumb hole as required by the prior art, and the hand of the supporting arm is thus left free for productive uses such as holding and cleaning paint brushes.

When it is desired to remove the palette, the wing nut 160 is loosened, the jaw 150 opened and the arm removed from the notch 120. Further, it will be noted that the palette according to the present invention may be used with equal efficacy by either left or right handed individuals by inverting the palette. For comfort, it is advisable that the lower surface of the palette that contacts the arm be as smooth as possible so it is preferred that the screw be flush with the palette surface and that the wing nut be on the upper surface.

While the embodiment of the invention shown and described is fully capable of achieving the results desired, it is to be understood that this embodiment has been shown and described for purposes of illustration only an not for purposes of limitation. Other variations in the form and details that occur to those skilled in the art and which arm within the spirit and scope of the invention are not specifically addressed. Therefore, the invention is limited only by the appended claims.

That which is claimed is:

1. A artist's palette comprising:
a panel having a shape adapted to overlie at least a portion of the arm of the artist;
a notch means positioned in said panel along one edge thereof, said notch means having dimensions sufficient to receive the arm of the artist; and
means for closing the open dimension of said notch means and further being moveable between a first open position wherein the arm of the artist may be inserted within said notch means and a second substantially closed position wherein the palette is supported by the arm of the artist.

2. The artist's palette according to claim 1 wherein said means for closing the open dimension of said notch means is pivotally connected to said panel.

3. The artist's palette according to claim 3 wherein said means for closing the open dimension of said notch means is selected from the group of connectors consisting of nut and bolt, nail, rivet, pop rivet, screw, peg, grommet and hook and loop fastener.

4. The artist's palette according to claim 1 wherein said palette is molded and the means for closing the open dimension is molded therewith for pivotal movement.

5. The artist's palette according to claim 1 wherein the means for closing the open dimension and said panel are connected with a snap fit connector.

6. The artist's palette according to claim 1 wherein said notch means includes a nose portion and wherein said means for closing the open dimension substantially spans the open dimension.

7. The artist's palette according to claim 6 wherein said means for closing the open dimension comprises an arcuate jaw member pivotally connected to said palette at one end and having a curved second nose at the opposite end such that when the jaw member is in the closed position the respective nose portion and second nose portion are substantially facing each other.

8. The artist's palette according to claim 7 further including a slot positioned proximate said notch means and wherein said jaw member is adjustably positioned for pivotal movement therein.

9. A artist's palette comprising:
a panel having a shape adapted to overlie at least a portion of the arm of the artist;
a notch positioned in said panel along one edge thereof, said notch having dimensions sufficient to receive the arm of the artist; and
a jaw being moveable between a first open position wherein the arm of the artist may be inserted within said notch and a second substantially closed position wherein the palette is supported by the arm of the artist.

10. The artist's palette according to claim 9 wherein said jaw is pivotally mounted to said palette proximate one side of said notch.

11. The artist's palette according to claim 10 wherein said jaw comprises an arcuate member pivotally connected to said palette at one end and having a curved second nose at the opposite end such that when the jaw is in the closed position the respective nose portion and second nose portion are substantially facing each other in notch closing relation.

12. The artist's palette according to claim 11 further including a slot positioned proximate said notch and wherein said jaw is adjustably positioned for movement therein.

13. The artist's palette according to claim 12 wherein said jaw is adjustably positioned for pivotal movement in said slot.
